(19) United States
(12) Patent Application Publication
(10) Pub. No.: US 2026/0186603 A1
(43) Pub. Date: Jul. 2, 2026

(54) TOUCH SENSING DEVICE AND TOUCH SENSING METHOD

(71) Applicant: LX SEMICON CO., LTD., Daejeon (KR)

(72) Inventors: Young Eun LEE, Daejeon (KR); Youn Soo KIM, Daejeon (KR); Sang Min CHOI, Daejeon (KR)

(73) Assignee: LX SEMICON CO., LTD., Daejeon (KR)

(21) Appl. No.: 19/132,029

(22) PCT Filed: Sep. 25, 2023
(86) PCT No.: PCT/KR2023/014590

§ 371 Date: May 22, 2025

(30) Foreign Application Priority Data
Nov. 22, 2022 (KR) 10-2022-0157318

(51) Int. Cl. G06F 3/041; G06F 3/044

(52) U.S. Cl. CPC G06F 3/04186; G06F 3/0446

(57) ABSTRACT

A touch sensing device according to one aspect of the present invention comprises: a first circuit which supplies a drive signal to a touch electrode; a second circuit which senses the amount of capacitance change occurring in the touch electrode; and a third circuit which generates first sensing data including a sensing value of each of a plurality of touch nodes on the basis of the sensed amount of capacitance change, determines whether to compensate touch sensitivity on the basis of the first sensing data, and when a determination is made to compensate touch sensitivity, generates second sensing data by adding a compensation value to the sensing value of at least one of the plurality of touch nodes.

### TECHNICAL FIELD

The present invention relates to a touch sensing device and a touch sensing method.

### BACKGROUND ART

With the development of an information-oriented society, demands for display devices for displaying images are increasing in various forms, and recently, various display devices such as liquid crystal display (LCD) devices or organic light emitting display (OLED) devices are being utilized.

Recently, display devices including touch panels capable of detecting touch input by a user's finger, a stylus pen, etc., are being widely used, departing from typical input methods using buttons, keyboards, mice, etc. Such display devices including touch panels include a touch sensing device for accurately detecting whether a touch occurs and the touch coordinates (touch positions).

When the grounding of a touch panel is weak, even if a touch occurs, a small change in capacitance may occur due to retransmission of adjacent touch electrodes. A state in which the grounding of the touch panel is weakly formed is referred to as a low ground mass (LGM) state, and the development of a technique for improving touch sensitivity in such an LGM state is required.

### DISCLOSURE

### Technical Problem

The present invention has been made to solve the above-described problems, and the technical object of the present invention is to provide a touch sensing device and a touch sensing method that may improve touch sensitivity in an LGM state.

In addition, another technical object of the present invention is to provide a touch sensing device and a touch sensing method that may improve touch sensitivity in an LGM state only by driving with a mutual capacitance method without driving with a self-capacitance method.

### Technical Solution

A touch sensing device according to an aspect of the present invention for achieving the above-described object includes: a first circuit configured to supply a drive signal to a touch electrode; a second circuit configured to sense an amount of capacitance change occurring in the touch electrode; and a third circuit configured to generate first sensing data including a sensing value of each of a plurality of touch nodes based on the sensed amount of capacitance change, to determine whether to compensate for touch sensitivity based on the first sensing data, and to generate second sensing data by adding a compensation value to the sensing value of at least one of the plurality of touch nodes when a determination is made to compensate for the touch sensitivity.

A touch sensing method according to another aspect of the present invention for achieving the above-described object includes: a step of supplying a drive signal to a first touch electrode and receiving an amount of capacitance change in a plurality of touch nodes from a second touch electrode; a step of determining a sensing value of each of the plurality of touch nodes based on the amount of capacitance change in the plurality of touch nodes and determining whether to compensate for touch sensitivity by using the sensing value of each of the plurality of touch nodes; and a step of, when a determination is made to compensate for the touch sensitivity, determining touch nodes included in a compensation area among the plurality of touch nodes and compensating for the touch sensitivity with respect to the determined touch nodes.

### Effect of the Invention

The present invention may increase a touch sensing value by a compensation value with respect to a large-area touch, thereby improving touch sensitivity in an LGM state.

In addition, the present invention may an apply a large compensation value to a compensation touch node whose touch sensing value has been greatly reduced due to a retransmission phenomenon, and may apply a small compensation value to or made no compensation on a compensation touch node whose touch sensing value has been relatively less reduced. Accordingly, the present invention may have an even sensing distribution while improving the sensing values of the compensation touch nodes in a large-area touch.

In addition, since the present invention may compensate for touch sensitivity only by increasing a touch sensing value, thereby improving touch sensitivity in an LGM state only by driving with a mutual capacitance method without driving with a self-capacitance method.

### BRIEF DESCRIPTION OF THE DRAWINGS

FIG. 1 is a block diagram illustrating a display device according to an embodiment of the present invention.

FIG. 2 is a block diagram schematically illustrating a configuration of a touch sensing device according to the present invention.

FIG. 3 is a block diagram illustrating a configuration of a compensation processor in FIG. 2.

FIG. 4 is a diagram for explaining an example of first sensing data of a large-area single touch.

FIG. 5 is a diagram for explaining an example of a compensation area determined based on the first sensing data shown in FIG. 4.

FIG. 6 is a diagram for explaining an example in which touch sensitivity is compensated for a compensation touch node included in the compensation area shown in FIG. 5.

FIG. 7 is a diagram for explaining an example of first sensing data of a large-area multi-touch.

FIG. 8 is a diagram for explaining an example of a compensation area determined based on the first sensing data shown in FIG. 7.

FIG. 9 is a diagram for explaining an example in which touch sensitivity is compensated for a compensation touch node included in the compensation area shown in FIG. 8.

FIG. 10 is a flowchart for explaining a touch sensing method performed by the touch sensing device according to an embodiment of the present invention.

### BEST MODE FOR CARRYING OUT THE INVENTION

Substantially the same reference numerals refer to substantially the same components throughout the specification. In the following description, detailed descriptions of the configuration and function not related to the core configuration of the present invention and already known in the technical field of the present invention may be omitted. The meaning of terms described in the present specification needs to be understood as follows.

When “includes”, “has”, “composed of”, and the like described in the present specification are used, another part may be added unless “only” is used. When a component is expressed in a singular form, it includes a plural number unless there is a special explicit description.

In a case of a description for a temporal relationship, for example, when a temporal sequence such as “after”, “subsequent to”, “next to”, and “before” is described, it may include a discontinuous case unless the term like “right away” or “directly” is used.

Although terms such as first and second are used to describe various components, these components are not limited by these terms. These terms are used only to distinguish one component from another component. Accordingly, a first component to be described blow may also be a second component within the technical spirit of the present disclosure.

A term “at least one” should be understood to include all combinations that may be presented from one or more related items. For example, “at least one of a first item, a second item, and a third item” may mean not only each of the first item, the second item, and the third item, but also combinations of all items that may be presented from two or more of the first item, the second item, and the third item.

Hereinafter, embodiments of the present specification are described in detail with reference to the accompanying drawings.

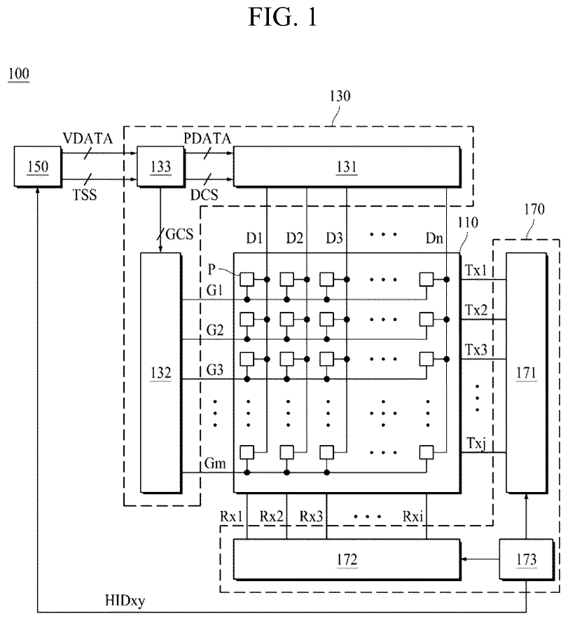

FIG. 1 is a block diagram illustrating a display device according to an embodiment of the present invention.

A display device 100 according to an embodiment of the present invention performs a display function and may be implemented as a flat panel display device such as a liquid crystal display (LCD) device or an organic light emitting diode (OLED) device. In the following embodiments, the display device 100 according to the embodiment of the present invention is described mainly as an organic light emitting diode display device, but it should be noted that the present invention is not limited thereto.

As shown in FIG. 1, the display device 100 according to the present invention includes a panel 110, a host system 150, a display driving device 130 for displaying an image on the panel 110, and a touch sensing device 170 for sensing a touch occurring on the panel 110.

The panel 110 may include a display panel and a touch panel. The touch panel may be implemented in a form built into the display panel. For example, the touch panel may be formed in the display panel as an on-cell type or an in-cell type. However, the present invention is not limited thereto, and the touch panel may also be provided as a physically separate configuration without being built into the display panel.

The panel 110 includes a display area that is an area where a plurality of pixels P are provided to display an image. The panel 110 includes a plurality of data lines D1 to Dn (n is a positive integer equal to or greater than 2), a plurality of gate lines G1 to Gm (m is a positive integer equal to or greater than 2), and the plurality of pixels P.

Each of the plurality of data lines D1 to Dn receives a data signal. Each of the plurality of gate lines G1 to Gm receives a gate signal. The plurality of data lines D1 to Dn and the plurality of gate lines G1 to Gm are arranged to intersect with each other on the substrate to define the plurality of pixels P. Each of the plurality of pixels P may be connected to any one of the plurality of data lines D1 to Dn and any one of the plurality of gate lines G1 to Gm.

Each of the plurality of pixels P may include a drive transistor, a scan transistor that is turned on by the gate signal of the gate lines G1 to Gm and supplies a data voltage of the data lines D1 to Dn to a gate electrode of the drive transistor, an organic light emitting diode that emits light according to a drain-source current of the drive transistor, and a capacitor for storing a voltage of the gate electrode of the drive transistor. Thus, each of the plurality of pixels P may emit light according to a current supplied to the organic light emitting diode.

In addition to the data lines D1 to Dn and the gate lines G1 to Gm, first and second touch electrodes may be formed on the panel 110. The first touch electrodes may be formed to intersect with the second touch electrodes. The first touch electrodes may be connected to the touch sensing device 170 through first touch lines Tx1 to Txj (j is a positive integer equal to or greater than 2). The second touch electrodes may be connected to the touch sensing device 170 through second touch lines Rx1 to Rxi (i is a positive integer equal to or greater than 2). A touch sensor may be formed at each of interparts of the first touch electrodes and the second touch electrodes. The touch sensor according to the embodiment of the present invention may be implemented with mutual capacitance.

The display driving device 130 allows the data signals to be supplied to the plurality of pixels P included in the panel 110 so that an image is displayed through the panel 110. To this end, the display driving device 130 may include a data driving circuit 131, a gate driving circuit 132, and a timing controller 133.

The data driving circuit 131 receives pixel data PDATA and a data control signal DCS from the timing controller 133. The data driving circuit 131 converts the pixel data PDATA in a digital form into an analog positive/negative polarity data signal according to the data control signal DCS, and supplies the analog positive/negative polarity data signal to the pixels P through the plurality of data lines D1 to Dn.

The gate driving circuit 132 receives a gate control signal GCS from the timing controller 133. The gate driving circuit 132 supplies the gate signals to the plurality of gate lines G1 to Gm according to the gate control signal GCS. Specifically, the gate driving circuit 132 generates the gate signal (or scan signal) synchronized with the data signal under the control of the timing controller 133, and sequentially supplies the generated gate signal to the gate lines G1 to Gm while shifting the generated gate signal.

The timing controller 133 receives digital video data VDATA and timing signals TSS from the host system 150. The timing signals TSS may include a reference clock signal (e.g., dot clock), a vertical synchronization signal, a horizontal synchronization signal, a data enable signal, etc. The vertical synchronization signal is a signal that defines one frame period. The horizontal synchronization signal is a signal that defines one horizontal period required to supply the data signals to the pixels P of one horizontal line in the panel 110. The data enable signal is a signal that defines a period during which valid data is input. The dot clock is a signal that is repeated at a predetermined short cycle.

The timing controller 133 may include a data processing unit (not shown) that generates the pixel data PDATA, the data control signal DCS, and the gate control signal GCS by using the digital video data VDATA and the timing signals TSS. In order to control the operation timing of the data driving circuit 131 and the gate driving circuit 132, the data processing unit of the timing controller 133 may generate the data control signal DCS for controlling the operation timing of the data driving circuit 112 and the gate control signal GCS for controlling the operation timing of the gate driving circuit 114 based on the timing signals TSS.

In addition, the data processing unit of the timing controller 133 may align the digital video data VDATA to match the structure of the pixel P formed on the panel 110 and convert the digital video data VDATA into the pixel data PDATA.

The timing controller 133 outputs the pixel data PDATA and the data control signal DCS to the data driving circuit 131 during a display driving period, and outputs the gate control signal GCS to the gate driving circuit 132.

The host system 150 is implemented as a television system, a navigation system, a set-top box, a DVD player, a Blu-ray player, an electronic whiteboard, a kiosk system, a personal computer (PC), a home theater system, a broadcast receiver, a phone system, etc., and may receive an input image. The host system 150 includes a system on chip (SoC) having a built-in scaler and converts digital video data VDATA of the input image into a format suitable for display on the panel 110. The host system 150 transmits the digital video data VDATA and the timing signals TSS to the timing controller 133.

The touch sensing device 170 supplies a drive signal to the first touch electrodes through the first touch lines Tx1 to Txj, and senses the amount of capacitance change in each of the touch sensors through the second touch lines Rx1 to Rxi. That is, the first touch lines Tx1 to Txj may be Tx lines for supplying the drive signal, and the second touch lines Rx1 to Rxi may be Rx lines for sensing the amount of capacitance change in each of the touch sensors.

The touch sensing device 170 may include a first circuit 171, a second circuit 172, and a third circuit 173. The first circuit 171, the second circuit 172, and the third circuit 173 may be integrated into one read-out IC (ROIC), but are not necessarily limited thereto.

The first circuit 171 supplies the drive signal to the first touch lines Tx1 to Txj, and the second circuit 172 receives the amounts of capacitance change in the touch sensors through the second touch lines Rx1 to Rxi. The second circuit 172 samples the amounts of capacitance change in the touch sensors received through the second touch lines Rx1 to Rxi, converts the sampled amounts into touch raw data being digital data, and outputs the touch raw data.

The third circuit 173 generates timing control signals for controlling the operation timings of the first circuit 171 and the second circuit 172. The third circuit 173 may also determine whether a touch occurs and the touch coordinates. The third circuit 173 may output touch coordinate data HIDxy including information on the touch coordinate(s) to the host system 150.

The host system 150 may analyze the touch coordinate data HIDxy input from the third circuit 173, and execute an application program linked to coordinates where a touch has occurred by the user. The host system 150 may transmit the digital video data VDATA and the timing signals TSS to the timing controller 133 according to the executed application program.

The touch generation device 170 may be a separate configuration from the data driving circuit 131 and the gate driving circuit 132 and may be provided as a separate drive chip outside the data driving circuit 131 and the gate driving circuit 132, but is not limited thereto. The touch generation device 170 may be implemented as an internal configuration of a drive IC including at least one of the data driving circuit 131 and the gate driving circuit 132 depending on the implementation method.

In particular, the touch generation device 170 according to the present invention may compensate for touch sensitivity for a touch node whose touch sensitivity has decreased in a low ground mass (LGM) state during touch sensing, and determine whether a touch occurs and the and the touch coordinates based on the compensated sensing data.

The panel 110 may be provided with the first touch electrodes arranged in a first direction (e.g., X-axis direction) and the second touch electrodes arranged in a second direction (e.g., Y-axis direction) intersecting the first direction (e.g., X-axis direction). The first direction (e.g., X-axis direction) may be a direction parallel to the gate lines G1 to Gm, and the second direction (e.g., Y-axis direction) may be a direction parallel to the data lines D1 to Dn. Mutual capacitance corresponding to the touch sensor may be formed in the interpart area of the first touch electrode and the second touch electrode.

In the case of the LGM state in which the panel 110 is not connected to the ground, when an object touches the panel 110 in a floating state, a coupling capacitance may be generated between the object and the first touch electrode and/or the second touch electrode, in addition to the mutual capacitance being generated between the first touch electrode and the second touch electrode. Accordingly, the drive signal applied through the first touch electrode may be input to a plurality of second touch electrodes that are in contact with the object through the object. That is, the object may form a current path. In this way, when a signal formed by the drive signal being input to another adjacent touch electrode through the object is referred to as a retransmission signal, a sensing signal and a retransmission signal by the drive signal may be simultaneously formed at a specific second touch electrode. In such a case, a normal sensing signal and the retransmission signal may have opposite signs. Accordingly, the touch sensitivity may be lowered by the retransmission signal.

Such a retransmission signal may be stronger as a touch area increases. Accordingly, when a large-area touch is made in the LGM state, even if a touch has occurred, it may be determined that there is no touch or the touch coordinates may be incorrectly recognized.

The touch generating device 170 according to the present invention may compensate for the sensing value reduced due to the retransmission signal generated in the LGM state during touch sensing, and determine whether the presence or absence of a touch occurs and the touch coordinates based on the compensated sensing value.

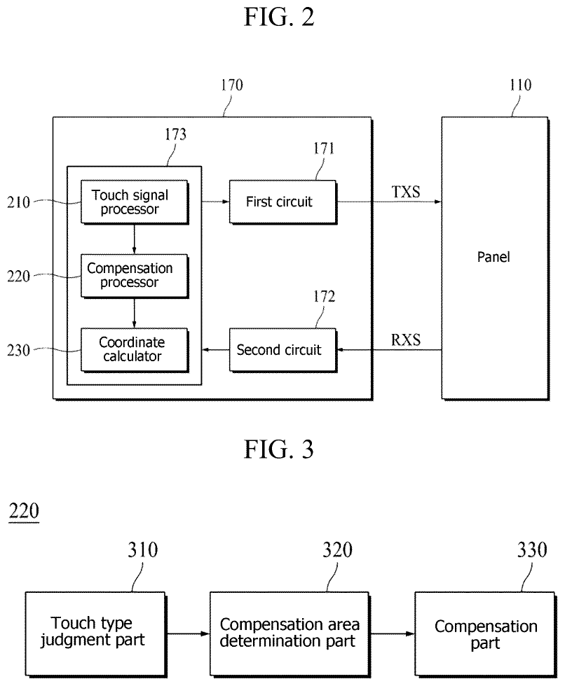

Hereinafter, the configuration of the touch generating device 170 according to the present invention is described in more detail with reference to FIGS. 2 to 8.

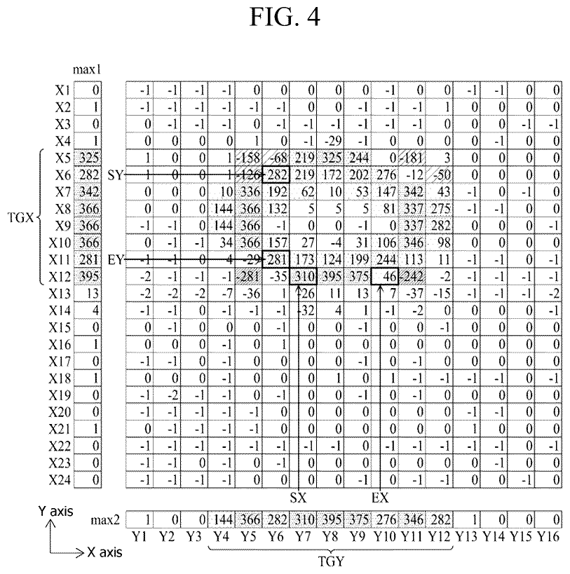

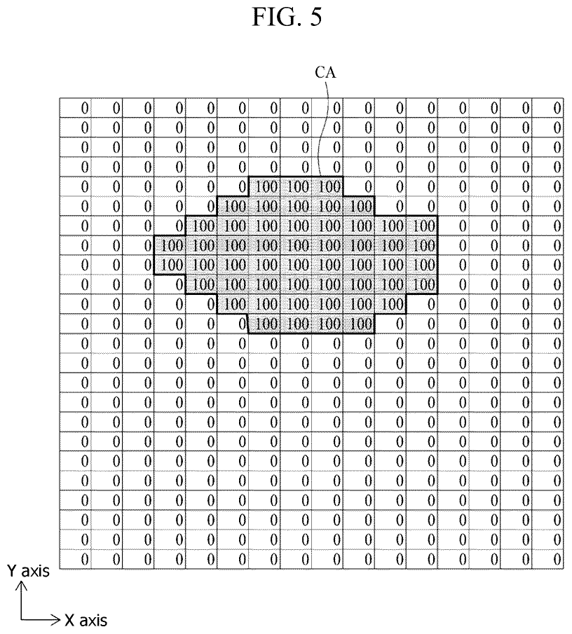

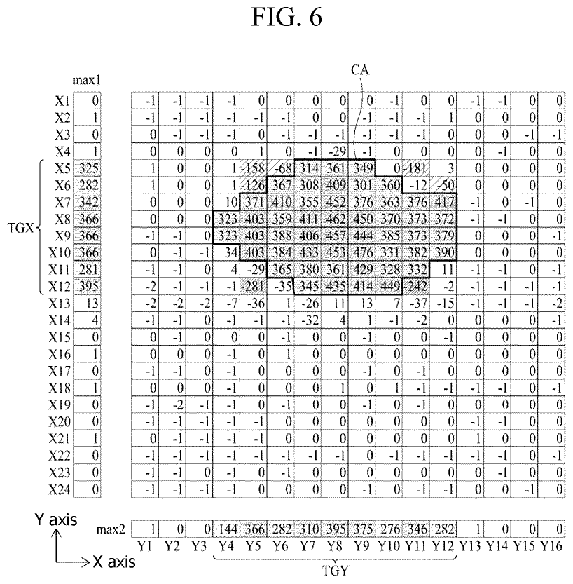

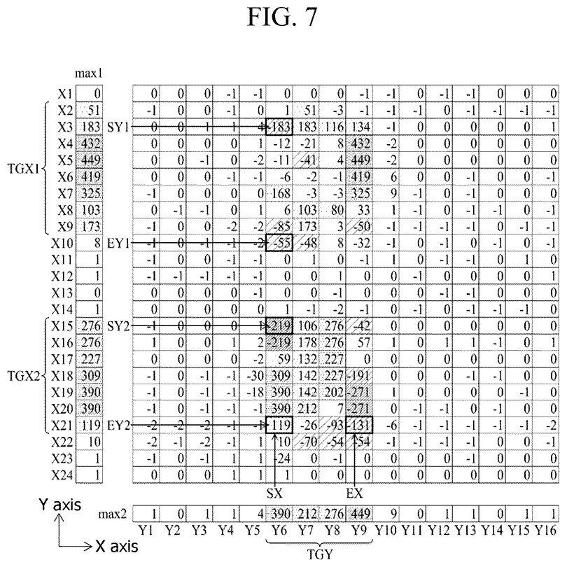

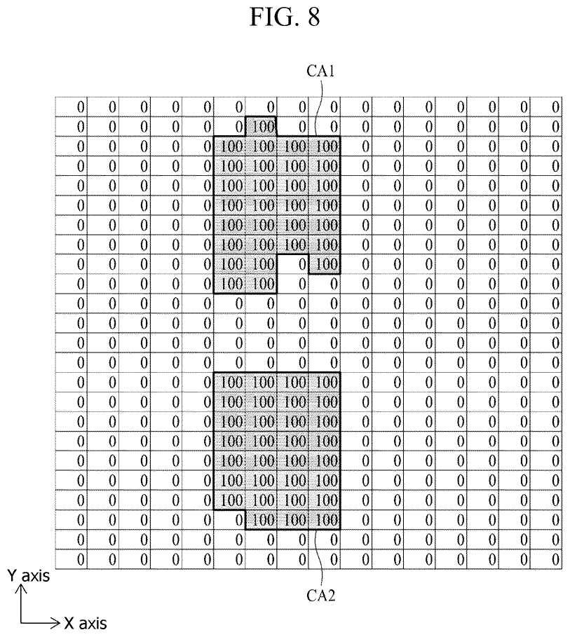

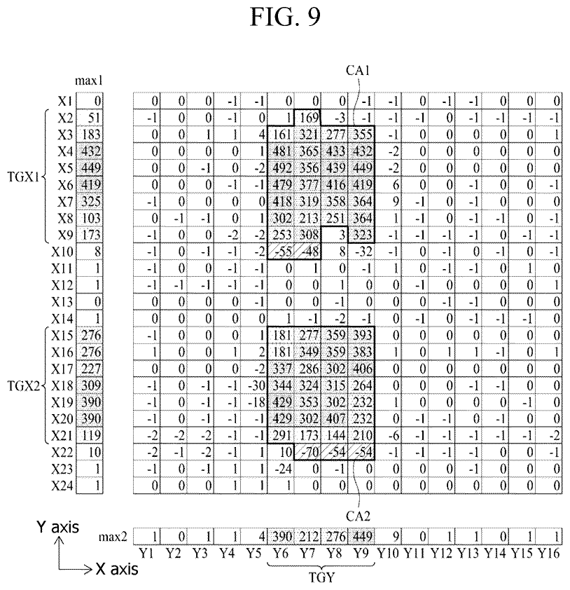

FIG. 2 is a block diagram schematically illustrating a configuration of the touch sensing device according to the present invention, FIG. 3 is a block diagram illustrating a configuration of a compensation processor in FIG. 2, FIG. 4 is a diagram for explaining an example of first sensing data of a large-area single touch, FIG. 5 is a diagram for explaining an example of a compensation area determined based on the first sensing data shown in FIG. 4, and FIG. 6 is a diagram for explaining an example in which touch sensitivity is compensated for a compensation touch node included in the compensation area shown in FIG. 5. FIG. 7 is a diagram for explaining an example of first sensing data of a large-area multi-touch, FIG. 8 is a diagram for explaining an example of a compensation area determined based on the first sensing data shown in FIG. 7, and FIG. 9 is a diagram for explaining an example in which touch sensitivity is compensated for a compensation touch node included in the compensation area shown in FIG. 8.

Referring to FIG. 2 and FIG. 3, the touch sensing device 170 includes the first circuit 171, the second circuit 172, and the third circuit 173.

The first circuit 171 selects a touch drive channel for outputting a drive signal under the control of the third circuit 173, and supplies a drive signal TXS to the first touch lines Tx1 to Txj connected to the selected touch drive channel. For example, the first circuit 171 may sequentially supply the drive signal TXS to the first touch lines Tx1 to Txj. Such a first circuit 171 may be a touch driving circuit that supplies the drive signal TXS to the first touch electrodes through the first touch lines Tx1 to Txj.

The second circuit 172 selects a touch sensing channel for receiving the amounts of capacitance change in the touch sensors under the control of the third circuit 173, and receives a sensing signal RXS including the amounts of capacitance change in the touch sensors through the second touch lines Rx1 to Rxi connected to the selected touch sensing channel. The second circuit 172 samples the amounts of capacitance change in the touch sensors received through the second touch lines Rx1 to Rxi, converts the sampled amounts into touch raw data being digital data, and outputs the touch raw data. Such a second circuit 172 may be a touch sensing circuit that senses the amounts of capacitance change in each of the touch sensors through the second touch lines Rx1 to Rxi.

The third circuit 173 may generate a touch drive setup signal for setting the touch drive channel through which the drive signal is to be output from the first circuit 171, and output the touch drive setup signal to the first circuit 171. The third circuit 173 may generate a touch sensing setup signal for setting the touch sensing channel through which the second circuit 172 is to receive the amounts of capacitance change in the touch sensors, and output the touch sensing setup signal to the second circuit 172. In addition, the third circuit 173 may generate timing control signals for controlling the operation timings of the first circuit 171 and the second circuit 172, and output the timing control signals to the first circuit 171 and the second circuit 172. Such a third circuit 173 may be a touch control circuit and may be implemented as a micro controller unit (MCU).

The third circuit 173 may determine whether a touch occurs and the touch coordinates based on the amount of capacitance change. The third circuit 173 may classify a touch into a general touch and a large-area touch, and in the case of the large-area touch, it may compensate for touch sensitivity for a touch node whose touch sensitivity has decreased in the LGM state and determine whether a touch occurs and the touch coordinates based on the compensated sensing value.

As shown in FIG. 2, the third circuit 173 may include a touch signal processor 210, a compensation processor 220, and a coordinate calculator 230.

The touch signal processor 210 may generate first sensing data including a sensing value of each of a plurality of touch nodes based on the amount of capacitance change. Specifically, the touch signal processor 210 may receive touch raw data from the second circuit 172. In such a case, the touch raw data may be data obtained by sampling the amounts of capacitance change in the touch sensors and converting the sampled amounts into digital data.

The touch signal processor 210 may generate the first sensing data including the sensing value of each of the plurality of touch nodes based on the touch raw data. The plurality of touch nodes may correspond to the plurality of touch sensors provided on the panel 110.

The touch signal processor 210 may set a baseline based on the touch raw data, and determine a generated difference value as a sensing value. The baseline herein may refer to initial raw data for the plurality of touch nodes in an untouched state. The touch signal processor 210 may determine a difference value between the initial raw data and the touch raw data as a sensing value with respect to each of the plurality of touch nodes. Subsequently, the touch signal processor 210 may generate the first sensing data including the sensing value of each of the plurality of touch nodes and transmit the first sensing data to the compensation processor 220.

The compensation processor 220 may determine whether to compensate for touch sensitivity based on the first sensing data, and compensate for the touch sensitivity for at least one of the plurality of touch nodes when a determination is made to compensate for the touch sensitivity. As shown in FIG. 3, the compensation processor 220 may include a touch type judgment part 310, a compensation area determination part 320, and a compensation part 330.

The touch type judgment part 310 may determine any one of a first type, a second type, and a third type as a touch type based on the first sensing data. Specifically, the touch type judgment part 310 may extract a maximum sensing value max1 per X-axis line and a maximum sensing value max2 per Y-axis line from the first sensing data, and determine the touch type based on the extracted maximum sensing value max1 per X-axis line and maximum sensing value max2 per Y-axis line.

The touch type judgment part 310 may extract the maximum sensing value max1 with respect to each of a plurality of X-axis lines. Each of the plurality of X-axis lines may include the sensing value of each of the plurality of touch nodes arranged in parallel in the X-axis direction. The touch type judgment part 310 may select a maximum value from the sensing values of the plurality of touch nodes arranged in a corresponding X-axis line, and determine the selected maximum value as the maximum sensing value max1 for the corresponding X-axis line.

The touch type judgment part 310 may extract the maximum sensing value max2 with respect to each of a plurality of Y-axis lines. Each of the plurality of Y-axis lines may include the sensing value of each of the plurality of touch nodes arranged in parallel in the Y-axis direction. The touch type judgment part 310 may select a maximum value from the sensing values of the plurality of touch nodes arranged in a corresponding Y-axis line, and determine the selected maximum value as the maximum sensing value max2 for the corresponding Y-axis line.

For example, when the first sensing data includes the sensing values of the plurality of touch nodes as shown in FIGS. 4 and 7, the touch type judgment part 310 may extract the maximum sensing value max1 with respect to each of 24 X-axis lines. Each of the 24 X-axis lines may include sensing values of 16 touch nodes along the X-axis direction. The touch type judgment part 310 may select a maximum value from the sensing values of the 16 touch nodes arranged along a corresponding X-axis line and determine the selected maximum value as the maximum sensing value max 1 for the corresponding X-axis line.

As an example, referring to FIG. 4, the touch type judgment part 310 may determine 0, which is the largest value among the sensing values of the 16 touch nodes arranged along the first X-axis line X1, as the maximum sensing value max1 of the first X-axis line X1. As another example, referring to FIG. 4, the touch type judgment part 310 may determine 366, which is the largest value among the sensing values of the 16 touch nodes arranged along the tenth X-axis line X10, as the maximum sensing value max 1 of the tenth X-axis line X10. The touch type judgment part 310 may sequentially extract the maximum sensing value max1 from the first X-axis line X1 to the last X-axis line X24 and generate first maximum sensing data.

In addition, the touch type judgment part 310 may extract the maximum sensing value max2 with respect to each of 16 Y-axis lines. Each of the 16 Y-axis lines may include the sensing values of 24 touch nodes along the Y-axis direction. The touch type judgment part 310 may select a maximum value from the sensing values of the 24 touch nodes arranged along a corresponding Y-axis line and determine the selected maximum value as the maximum sensing value max2 for the corresponding Y-axis line.

For example, referring to FIG. 4, the touch type judgment part 310 may determine 1, which is the maximum value among the sensing values of the 24 touch nodes arranged along the first Y-axis line Y1, as the maximum sensing value max2 of the first Y-axis line Y1. As another example, referring to FIG. 4, the touch type judgment part 310 may determine 276, which is the maximum value among the sensing values of the 24 touch nodes arranged along the tenth Y-axis line Y10, as the maximum sensing value max2 of the tenth Y-axis line Y10. The touch type judgment part 310 may sequentially extract the maximum sensing value max2 from the first Y-axis line Y1 to the last Y-axis line Y16 and generate second maximum sensing data.

On the other hand, the touch type judgment part 310 may determine X-axis touch groups TGX and Y-axis touch groups TGY based on the maximum sensing value max1 per X-axis line and the maximum sensing value max2 per Y-axis line, and determine the touch type by using the X-axis touch groups TGX and the Y-axis touch groups TGY. Specifically, the touch type judgment part 310 may determine the X-axis touch group TGX based on the maximum sensing values max1 sequentially stored from the first X-axis line to the last X-axis line. The touch type judgment part 310 may determine, as the X-axis touch group TGX, X-axis lines corresponding to the maximum sensing values max1 exceeding a first threshold value among the maximum sensing values max1. The X-axis touch group TGX may comprise one, or two or more adjacent X-axis lines.

In addition, the touch type judgment part 310 may determine the Y-axis touch group TGY based on the maximum sensing values max2 sequentially stored from the first Y-axis line to the last Y-axis line. The touch type judgment part 310 may determine, as the Y-axis touch group TGY, Y-axis lines corresponding to the maximum sensing values max2 exceeding a second threshold value among the maximum sensing values max2. The second threshold value may be the same as or different from the first threshold value. In addition, the Y-axis touch group TGY may comprise one, or two or more adjacent Y-axis lines.

For example, when the first sensing data includes the sensing values of the plurality of touch nodes as shown in FIG. 4, the touch type judgment part 310 may determine, as the X-axis touch group TGX, the X-axis lines corresponding to the maximum sensing values max1 exceeding the first threshold value among the maximum sensing values max1 sequentially stored from the first X-axis line to the last X-axis line.

As an example, referring to FIG. 4, the touch type judgment part 310 may search for the maximum sensing values max1 exceeding the first threshold value, for example, 40, among the maximum sensing values max1 sequentially stored from the first X-axis line X1 to the last X-axis line X24. The touch type judgment part 310 may determine the X-axis lines X5 to X12 corresponding to the searched maximum sensing values max1 as the X-axis touch group TGX. As another example, the touch type judgment part 310 may determine two or more X-axis touch groups TGX. Referring to FIG. 7, the touch type judgment part 310 may search for the maximum sensing values max1 exceeding the first threshold value, for example, 40, among the maximum sensing values max1 sequentially stored from the first X-axis line X1 to the last X-axis line X24. The touch type judgment part 310 may determine a first X-axis touch group TGX1 and a second X-axis touch group TGX2 by grouping the X-axis lines X2 to X9 and X15 to X21 corresponding to the searched maximum sensing values max1 into adjacent X-axis lines.

In addition, the touch type judgment part 310 may determine, as the Y-axis touch group TGY, Y-axis lines corresponding to the maximum sensing values max2 exceeding the second threshold value among the maximum sensing values max2 sequentially stored from the first Y-axis line Y1 to the last Y-axis line Y16.

As an example, referring to FIG. 4, the touch type judgment part 310 may search for the maximum sensing values max2 exceeding the second threshold value, for example, 40, among the maximum sensing values max2 sequentially stored from the first Y-axis line Y1 to the last Y-axis line Y16. The touch type judgment part 310 may determine, as the Y-axis touch group TGY, the Y-axis lines Y6 to Y9 corresponding to the searched maximum sensing values max2.

On the other hand, the touch type judgment part 310 may determine the touch type by using at least one of the range and number of each of the X-axis touch groups TGX and the Y-axis touch groups TGY.

The touch type judgment part 310 may determine the touch type by using the range of the X-axis touch group TGX and the range of the Y-axis touch group TGY. The touch type judgment part 310 may calculate a touch area by using the range of the X-axis touch group TGX and the range of the Y-axis touch group TGY. The touch area is the size of the touch area, and may correspond to the number of touch nodes arranged in an area where the range of the X-axis touch group TGX and the range of the Y-axis touch group TGY intersect with each other.

As an example, the range of the X-axis touch group TGX may include four X-axis lines, and the range of the Y-axis touch group TGY may include five Y-axis lines. In such a case, the touch type judgment part 310 may judge that the touch area corresponds to 20 touch nodes arranged in the area where the range of the X-axis touch group TGX and the range of the Y-axis touch group TGY intersect with each other.

On the other hand, the touch type judgment part 310 may calculate the touch area for each touch area. When the number of at least one of the X-axis touch groups TGX and the Y-axis touch groups TGY is two or more, the touch type judgment part 310 may calculate the touch area with respect to each of a plurality of touch areas.

As an example, the X-axis touch group TGX may include the first X-axis touch group TGX1 and the second X-axis touch group TGX2, four X-axis lines may be included in the range of the first X-axis touch group TGX1, and five X-axis lines may be included in the range of the second X-axis touch group TGX2. The Y-axis touch group TGY may be one, and 5 Y-axis lines may be included in the range of the Y-axis touch group TGY. In such a case, the touch type judgment part 310 may judge that a first touch area corresponds to 20 touch nodes arranged in an area where the range of the first X-axis touch group TGX1 and the range of the Y-axis touch group TGY intersect with each other, and judge that a second touch area corresponds to 25 touch nodes arranged in an area where the range of the second X-axis touch group TGX2 and the range of the Y-axis touch group TGY intersect with each other.

When the touch area is less than a preset area reference value, the touch type judgment part 310 may determine the touch type as the first type. When there are a plurality of touch areas and all of the plurality of touch areas are less than the preset area reference value, the touch type judgment part 310 may determine the touch type as the first type. Since a touch with a small area generates no retransmission signal or generates a weak retransmission signal and thus does not affect touch sensitivity, the touch sensing device 170 according to the present invention may classify the touch with a small area as the first type and not perform touch sensitivity compensation.

The touch type judgment part 310 may determine the touch type by using the number of X-axis touch groups TGX and the number of Y-axis touch groups TGY.

In an embodiment, when the number of X-axis touch groups TGX and the number of Y-axis touch groups TGY are all 2 or more, the touch type judgment part 310 may determine the touch type as the first type. A single touch may represent that the number of X-axis touch groups TGX and the number of Y-axis touch groups TGY are all 1, and a multi-touch may represent that at least one of the number of X-axis touch groups TGX and the number of Y-axis touch groups TGY is 2 or more. When two multi-touches are made on the same line, any one of the number of X-axis touch groups TGX and the number of Y-axis touch groups TGY may be 1 and the other may be 2. However, when two multi-touches are not made on the same line, the number of X-axis touch groups TGX and the number of Y-axis touch groups TGY may be all 2.

The retransmission phenomenon occurring in the LGM state also appears in not only a single touch but also a multi-touch, and in the case of the multi-touch, the phenomenon may increase as a touched area on the same line becomes larger. When the multi-touch is not made on the same line but on different lines, since no retransmission signal is generated or a generated retransmission signal is weak and does not affect touch sensitivity, the touch sensing device 170 according to the present invention may classify a touch with a small area as the first type and not perform touch sensitivity compensation.

In an embodiment, when the number of X-axis touch groups TGX and the number of Y-axis touch groups TGY are all 1, the touch type judgment part 310 may determine the touch type as the second type. The second type may represent a large-area single touch. In addition, when any one of the number of X-axis touch groups TGX and the number of Y-axis touch groups TGY is 1 and the other is 2 or more, the touch type judgment part 310 may determine the touch type as the third type. The third type may represent a large-area multi-touch made on the same line.

When the touch type is determined as the first type, the touch type judgment part 310 may transmit the first sensing data to the coordinate calculator 230. That is, the touch sensing device 170 according to the present invention may determine whether a touch occurs and the touch coordinates based on the first sensing data in which touch sensitivity compensation has not been performed on a small-area single touch and a multi-touch that is not made on the same line.

On the other hand, when the touch type is determined as any one of the second type and the third type, the touch type judgment part 310 may transmit the first sensing data to the compensation area determination part 320. That is, the touch sensing device 170 according to the present invention may perform touch sensitivity compensation with respect to a large-area single touch and a large-area multi-touch made on the same line.

When the touch type is determined as any one of the second type and the third type, the compensation area determination part 320 may predict a touch area based on the sensing value of each of the plurality of touch nodes included in the first sensing data, and determine the predicted touch area as a compensation area CA. The compensation area determination part 320 may predict the touch area by comparing the sensing value of each of the plurality of touch nodes with a touch reference value.

Specifically, when the touch type is the second type, the compensation area determination part 320 may predict one touch area by comparing the sensing value of each of the plurality of touch nodes included in the first sensing data with a first touch reference value. The compensation area determination part 320 may compare the sensing values with the first touch reference value while scanning an entire area or a partial area.

The compensation area determination part 320 may sequentially scan the sensing values of the touch nodes along the line.

In an embodiment, the compensation area determination part 320 may sequentially scan the sensing values of the touch nodes along the X-axis direction with respect to each of the plurality of X-axis lines and compare the sensing values with the first touch reference value. In such a case, the compensation area determination part 320 may scan an entire area, scan a partial area belonging to the range of the X-axis touch group TGX, or scan a partial area where the range of the X-axis touch group TGX and the range of the Y-axis touch group TGY intersect with each other.

In another embodiment, the compensation area determination part 320 may compare the sensing values with the first touch reference value while sequentially scanning the sensing values of the touch nodes along the Y-axis direction with respect to each of the plurality of Y-axis lines. In such a case, the compensation area determination part 320 may scan an entire area, scan a partial area belonging to the range of the Y-axis touch group TGY, or scan a partial area where the range of the X-axis touch group TGX and the range of the Y-axis touch group TGY intersect with each other.

The compensation area determination part 320 may determine a start node and an end node with respect to each line, and predict a gap between the start node and the end node as the touch area.

In an embodiment, the compensation area determination part 320 may determine the start node and the end node with respect to each of the plurality of X-axis lines. The compensation area determination part 320 may sequentially scan the sensing values of the touch nodes along the X-axis line, determine, as the start node, a first touch node whose sensing value is greater than the first touch reference value, and determine, as the end node, a last touch node whose sensing value is greater than the first touch reference value. In such a case, a Y-axis line, where the start node is arranged, and a Y-axis line, where the end node is arranged, may be included in the range of the Y-axis touch group TGY. The compensation area determination part 320 may predict a gap between the start node and the end node as the touch area with respect to each of the plurality of X-axis lines.

For example, when the first sensing data is as shown in FIG. 4, the compensation area determination part 320 may determine the start node and the end node with respect to each of the plurality of X-axis lines X1 to X24. For example, the compensation area determination part 320 may sequentially scan the sensing values of the touch nodes along the X-axis line X12, determine, as a start node SX, a touch node whose sensing value ‘310’ is greater than the first touch reference value ‘40’, and determine, as an end node EX, a touch node whose sensing value ‘46’ is greater than the first touch reference value ‘40’. In such a case, the Y-axis line Y7, where the start node SX is arranged, and the Y-axis line Y10, where the end node EX is arranged, may be included in the range of the Y-axis touch group TGY. The compensation area determination part 320 may predict a gap between the start node SX and the end node EX as the touch area. The compensation area determination part 320 may sequentially determine the start node and the end node from the first X-axis line X1 to the last X-axis line X24, and predict the gap between the start node and the end node as the touch area. The compensation area determination part 320 may determine one predicted touch area as the compensation area CA as shown in FIG. 5.

In another embodiment, the compensation area determination part 320 may determine the start node and the end node with respect to each of the plurality of Y-axis lines. The compensation area determination part 320 may sequentially scan the sensing values of the touch nodes along the Y-axis line, determine, as the start node, a first touch node whose sensing value is greater than the first touch reference value, and determine, as the end node, a last touch node whose sensing value is greater than the first touch reference value. In such a case, an X-axis line, where the start node is arranged, and an X-axis line, where the end node is arranged, may be included in the range of the X-axis touch group. The compensation area determination part 320 may predict a gap between the start node and the end node as the touch area with respect to each of the plurality of Y-axis lines.

For example, when the first sensing data is as shown in FIG. 4, the compensation area determination part 320 may determine the start node and the end node with respect to each of the plurality of Y-axis lines Y1 to Y16. For example, the compensation area determination part 320 may sequentially scan the sensing values of the touch nodes along the Y-axis line Y6, determine, as a start node SY, a touch node whose sensing value ‘282’ is greater than the first touch reference value ‘40’, and determine, as an end node EY, a touch node whose sensing value ‘281’ is greater than the first touch reference value ‘40’. In such a case, the X-axis line X6, where the start node SY is arranged, and the X-axis line X11, where the end node EY is arranged, may be included in the range of the X-axis touch group TGX. The compensation area determination part 320 may predict a gap between the start node SY and the end node EY as the touch area. The compensation area determination part 320 may sequentially determine the start node and the end node from the first Y-axis line Y1 to the last Y-axis line Y16, and predict the gap between the start node and the end node as the touch area. The compensation area determination part 320 may determine one predicted touch area as the compensation area CA as shown in FIG. 5.

On the other hand, when the touch type is the third type, the compensation area determination part 320 may compare the absolute value of the sensing value of each of the plurality of touch nodes included in the first sensing data with a second touch reference value, and predict at least two or more touch areas. In the case of the second type that is a large-area single touch, the compensation area determination part 320 may predict the touch area based on ‘+’ sensing values, and in the case of the third type that is a large-area multi-touch, the compensation area determination part 320 may predict the touch area based on ‘+’ and ‘-’ sensing values. Accordingly, unlike the second type, the compensation area determination part 320 may compare the absolute value of the sensing value with the second touch reference value. The compensation area determination part 320 may compare the sensing value with the second touch reference value while scanning an entire area or a partial area.

The compensation area determination part 320 may sequentially scan the sensing values of the touch nodes along the line.

In an embodiment, the compensation area determination part 320 may sequentially scan the sensing values of the touch nodes along the X-axis direction with respect to each of the plurality of X-axis lines and compare the absolute values of the sensing values with the second touch reference value. In such a case, the compensation area determination part 320 may scan an entire area, scan a partial area belonging to the range of the X-axis touch group TGX, or scan a partial area where the range of the X-axis touch group TGX and the range of the Y-axis touch group TGY intersect with each other.

In another embodiment, the compensation area determination part 320 may sequentially scan the sensing values of the touch nodes along the Y-axis direction with respect to each of the plurality of Y-axis lines and compare the absolute values of the sensing values with the second touch reference value. In such a case, the compensation area determination part 320 may scan an entire area, scan a partial area belonging to the range of the Y-axis touch group TGY, or scan a partial area where the range of the X-axis touch group TGX and the range of the Y-axis touch group TGY intersect with each other.

The compensation area determination part 320 may determine the start node and the end node with respect to each line, and predict a gap between the start node and the end node as a touch area.

In an embodiment, the compensation area determination part 320 may determine the start node and the end node with respect to each of the plurality of X-axis lines. The compensation area determination part 320 may sequentially scan the sensing values of the touch nodes along the X-axis line, determine, as the start node, a first touch node whose absolute value of the sensing value is greater than the second touch reference value, and determine, as the end node, a last touch node whose absolute value of the sensing value is greater than the second touch reference value. In such a case, a Y-axis line, where the start node is arranged, and a Y-axis line, where the end node is arranged, may be included in any one of the range of one Y-axis touch group TGY and the range of a Y-axis margin range. The Y-axis margin range may include at least one Y-axis line arranged adjacent to the Y-axis touch group TGY. When the touch type is the third type, since not only ‘+’ sensing values but also ‘−’ sensing values are predicted as touch areas, the compensation area determination part 320 may predict the touch area by extending to the Y-axis margin range in addition to the Y-axis touch group TGY determined based on a maximum value.

When there are a plurality of Y-axis touch groups TGY, the compensation area determination part 320 may determine the start node and the end node with respect to each of the plurality of Y-axis touch groups. For example, when the Y-axis touch groups include two touch groups: a first Y-axis touch group and a second Y-axis touch group, the compensation area determination part 320 may sequentially scan the sensing values of the touch nodes along the X-axis line, determine, as a first start node, a first touch node whose absolute value of the sensing value is greater than the second touch reference value among touch nodes whose Y-axis line is within the range of the first Y-axis touch group and a first Y-axis margin range, and determine, as a first end node, a last touch node whose absolute value of the sensing value is greater than the second touch reference value. In addition, the compensation area determination part 320 may determine, as a second start node, a first touch node whose absolute value of the sensing value is greater than the second touch reference value among touch nodes whose Y-axis line is within the range of a second Y-axis touch group and a second Y-axis margin range, and determine, as a second end node, a last touch node whose absolute value of the sensing value is greater than the second touch reference value.

The compensation area determination part 320 may predict a gap between the start node and the end node as the touch area with respect to each of the plurality of X-axis lines.

For example, when the first sensing data is as shown in FIG. 7, the compensation area determination part 320 may determine the start node and the end node with respect to each of the plurality of X-axis lines X1 to X24. As an example, the compensation area determination part 320 may sequentially scan the sensing values of the touch nodes along the X-axis line X21, determine, as the start node SX, a touch node whose absolute value ‘119’ of a sensing value ‘119’ is greater than the second touch reference value ‘40’, and determine, as the end node EX, a touch node whose absolute value ‘131’ of a sensing value ‘−131’ is greater than the second touch reference value ‘40’. In such a case, the Y-axis line Y6, where the start node SX is arranged, and the Y-axis line Y9, where the end node EX is arranged, may be included in any one of the range of the Y-axis touch group TGY and the Y-axis margin range. The compensation area determination part 320 may predict a gap between the start node SX and the end node EX as the touch area. The compensation area determination part 320 may sequentially determine the start node and the end node from the first X-axis line X1 to the last X-axis line X24, and predict the gap between the start node and the end node as the touch area. The compensation area determination part 320 may determine two predicted touch areas as two compensation areas CA1 and CA2 as shown in FIG. 8.

In another embodiment, the compensation area determination part 320 may determine the start node and the end node with respect to each of the plurality of Y-axis lines. The compensation area determination part 320 may sequentially scan the sensing values of the touch nodes along the Y-axis line, determine, as the start node, a first touch node whose absolute value of the sensing value is greater than the second touch reference value, and determine, as the end node, a last touch node whose absolute value of the sensing value is greater than the second touch reference value. In such a case, an X-axis line, where the start node is arranged, and an X-axis line, where the end node is arranged, may be included in any one of the range of the X-axis touch group TGX and an X-axis margin range. The X-axis margin range may include at least one X-axis line arranged adjacent to the X-axis touch group TGX. When the touch type is the third type, since not only ‘+’ sensing values but also ‘-’ sensing values are predicted as touch areas, the compensation area determination part 320 may predict the touch area by extending to the X-axis margin range in addition to the X-axis touch group TGX determined based on a maximum value.

When there are a plurality of X-axis touch groups TGX, the compensation area determination part 320 may determine the start node and the end node with respect to each of the plurality of X-axis touch groups. For example, when the X-axis touch group includes two touch groups: a first X-axis touch group TGX1 and a second X-axis touch group TGX2, the compensation area determination part 320 may sequentially scan the sensing values of the touch nodes along the Y-axis line, determine, as a first start node, a first touch node whose absolute value of the sensing value is greater than the second touch reference value among touch nodes whose X-axis line is within the range of the first X-axis touch group TGX1 and a first X-axis margin range, and determine, as a first end node, a last touch node whose absolute value of the sensing value is greater than the second touch reference value. In addition, the compensation area determination part 320 may determine, as a second start node, a first touch node whose absolute value of the sensing value is greater than the second touch reference value among touch nodes whose X-axis line is within the range of the second X-axis touch group TGX2 and a second X-axis margin range, and determine, as a second end node, a last touch node whose absolute value of the sensing value is greater than the second touch reference value.

The compensation area determination part 320 may predict a gap between the start node and the end node as the touch area with respect to each of the plurality of Y-axis lines.

For example, when the first sensing data is as shown in FIG. 7, the compensation area determination part 320 may determine the start node and the end node with respect to each of the plurality of Y-axis lines Y1 to Y16. As an example, the compensation area determination part 320 may sequentially scan the sensing values of the touch nodes along the Y-axis line Y6. Since the X-axis touch group TGX includes two touch groups: the first X-axis touch group TGX1 and the second X-axis touch group TGX2, the compensation area determining unit 320 may determine, as a first start node SY1, a first touch node whose absolute value ‘183’ of a sensing value ‘−183’ is greater than the second touch reference value ‘40’ among touch nodes whose X-axis line is within the range of the first X-axis touch group TGX1 and the first X-axis margin range, and determine, as a first end node EY1, a last touch node whose absolute value ‘55’ of a sensing value ‘−55’ is greater than the second touch reference value ‘40’. In addition, the compensation area determination part 320 may determine, as a second start node SY2, a first touch node whose absolute value ‘219’ of a sensing value ‘−219’ is greater than the second touch reference value ‘40’ among touch nodes whose X-axis line is within the range of the second X-axis touch group TGX2 and the second X-axis margin range, and determine, as a second end node EY2, a last touch node whose absolute value ‘119’ of a sensing value ‘119’ is greater than the second touch reference value ‘40’. The compensation area determination part 320 may sequentially determine the start node and the end node from the first Y-axis line Y1 to the last Y-axis line Y16, and predict a gap between the start node and the end node as the touch area. The compensation area determination part 320 may determine two predicted touch areas as the two compensation areas CA1 and CA2 as shown in FIG. 8.

The compensation part 330 compensates for touch sensitivity with respect to each of compensation touch nodes included in the compensation area CA. The compensation part 330 may generate second sensing data by adding a compensation value to the sensing value of each of the compensation touch nodes.

The compensation value may be determined based on the maximum sensing value max1 per X-axis line and the maximum sensing value max2 per Y-axis line that are extracted from the first sensing data. The compensation part 330 may determine a compensation value for a corresponding compensation touch node based on an average value of the maximum sensing value max1 of the X-axis line and the maximum sensing value max2 of the Y-axis line, the compensation touch nodes being located on the X-axis line and the Y-axis line.

In an embodiment, the compensation part 330 may determine the average value of the maximum sensing value max1 of the X-axis line and the maximum sensing value max2 of the Y-axis line as a compensation value for a corresponding compensation touch node, the compensation touch nodes being located on the X-axis line and the Y-axis line.

In another embodiment, based on the average value of the maximum sensing value max1 of the X-axis line and the maximum sensing value max2 of the Y-axis line and weights for the compensation touch nodes, the compensation touch nodes being located on the X-axis line and the Y-axis line, the compensation part 330 may determine a compensation value for a corresponding compensation touch node. The compensation part 330 may determine a weight for a compensation touch node based on the sensing value of the compensation touch node. The compensation part 330 may determine a sensing period including the sensing value of the compensation touch node among a plurality of sensing periods, and determine a weight corresponding to the determined sensing period as the weight for the compensation touch node.

The sensing periods may be divided into a plurality of periods based on the sensing value, and different weights may be set for the plurality of sensing periods, respectively. A low weight may be set for a sensing period including a high sensing value, and a high weight may be set for a sensing period including a low sensing value. That is, the sensing period may include a first sensing period and a second sensing period, and in such a case, sensing values included in the first sensing period may be greater than sensing values included in the second sensing period. A weight corresponding to the first sensing period may be smaller than a weight corresponding to the second sensing period. Such sensing periods and weights may vary depending on the design.

The compensation part 330 may determine a weight for the compensation touch node based on the sensing value of the compensation touch node, and determine a compensation value for the compensation touch node by multiplying the average value of the maximum sensing value max1 of the X-axis line and the maximum sensing value max2 of the Y-axis line by the weight.

For example, the sensing period may include six sensing periods. The first sensing period includes 400 or more sensing values, and the weight may be set to 0. The second sensing period includes sensing values of 300 or more and less than 400, and the weight may be set to 0.1. The third sensing period includes sensing values of 200 or more and less than 300, and the weight may be set to 0.3. The fourth sensing period includes sensing values of 100 or more and less than 200, and the weight may be set to 0.7. The fifth sensing period includes sensing values of 50 or more and less than 100, and the weight may be set to 0.9. The sixth sensing period includes sensing values of less than 50, and the weight may be set to 1.2.

Referring to FIGS. 4 and 6, in the case of a large-area single touch, the compensation part 330 may compensate for touch sensitivity with respect to each of the compensation touch nodes included in the compensation area CA. The compensation part 330 may generate the second sensing data by adding the compensation value to the sensing value of each of the compensation touch nodes. The compensation part 330 may determine a weight for the compensation touch node based on the sensing value of the compensation touch node.

For example, in the case of a compensation touch node arranged in an area where the ninth X-axis line X9 and the eighth Y-axis line Y8 intersect with each other, the compensation part 330 may determine the weight to 1.2 because the sensing value of the compensation touch node is 0. The compensation part 330 may calculate an average value of 366, which is the maximum value max1 of the ninth X-axis line X9, and 395, which is the maximum value max2 of the eighth Y-axis line Y8, and multiply the average value 380.5 by the weight 1.2 to calculate a compensation value 456.6. The compensation part 330 may compensate for touch sensitivity by adding the compensation value 456.6 to the sensing value 0 of the compensation touch node. As a result of rounding off the result value, the sensing value of the compensation touch node may be corrected from 0 to 457.

On the other hand, in the case of a compensation touch node arranged in an area where the ninth X-axis line X9 and the fifth Y-axis line Y5 intersect with each other, the compensation part 330 may determine the weight to 0.1 because the sensing value of the compensation touch node is 366. The compensation part 330 may calculate an average value of 366, which is the maximum value max1 of the ninth X-axis line X9, and 366, which is the maximum value max2 of the fifth Y-axis line Y5, and multiply the average value 366 by the weight 0.1 to calculate a compensation value 36.6. The compensation part 330 may compensate for touch sensitivity by adding the compensation value 36.6 to the sensing value 366 of the compensation touch node. As a result of rounding off the result value, the sensing value of the compensation touch node may be corrected from 366 to 403.

In this way, the compensation part 330 may apply a large compensation value to a compensation touch node whose touch sensing value has been greatly reduced due to the retransmission phenomenon in the compensation area CA, and may apply a small compensation value to or made no compensation on a compensation touch node whose touch sensing value has been relatively less reduced. As a result, as shown in FIG. 6, the touch sensing device 170 according to the present invention may have an even sensing distribution while improving the sensing values of the compensation touch nodes in a large-area single touch.

In addition, referring to FIGS. 7 and 9, in the case of a large-area multi-touch, the compensation part 330 may compensate for touch sensitivity with respect to the compensation touch nodes included in the first compensation area CAL and the compensation touch nodes included in the second compensation area CA2. The compensation part 330 may generate the second sensing data by adding a compensation value to the sensing value of each of the compensation touch nodes. The compensation part 330 may determine a weight for the compensation touch node based on the sensing value of the compensation touch node.

For example, in the case of a compensation touch node arranged in an area where the ninth X-axis line X9 and the sixth Y-axis line Y6 intersect with each other, the compensation part 330 may determine the weight to 1.2 because the sensing value of the compensation touch node is −85. The compensation part 330 may calculate an average value of 173, which is the maximum value max1 of the ninth X-axis line X9, and 390, which is the maximum value max2 of the sixth Y-axis line Y6, and multiply the average value 281.5 by the weight 1.2 to calculate a compensation value 337.8. The compensation part 330 may compensate for touch sensitivity by adding the compensation value 337.8 to the sensing value −85 of the compensation touch node. As a result of rounding off the result value, the sensing value of the compensation touch node may be corrected from −85 to 253.

On the other hand, in the case of a compensation touch node arranged in an area where the fifth X-axis line X5 and the ninth Y-axis line Y9 intersect with each other, the compensation part 330 may determine the weight to 0 because the sensing value of the compensation touch node is 449. The compensation part 330 may determine the compensation value to 0 because the weight is 0. That is, the compensation part 330 may not compensate for the sensing value of the compensation touch node for touch sensitivity.

In this way, the compensation part 330 may apply a large compensation value to a compensation touch node whose touch sensing value has been greatly reduced due to the retransmission phenomenon in the compensation area CA, and may apply a small compensation value to or made no compensation on a compensation touch node whose touch sensing value has been relatively less reduced. As a result, as shown in FIG. 9, the touch sensing device 170 according to the present invention may have an even sensing distribution while improving the sensing values of the compensation touch nodes in a large-area multi-touch.

When the compensation for touch sensitivity for the compensation touch nodes included in the compensation area CA is completed, the compensation part 330 may provide the second sensing data with the compensated touch sensitivity to the coordinate calculator 230.

Referring back to FIG. 2, the coordinate calculator 230 may determine whether a touch occurs and the touch coordinates based on the first sensing data or the second sensing data. Specifically, when the touch type judgment part 310 determines that the touch type is the first type, the coordinate calculator 230 may input the first sensing data. In such a case, the coordinate calculator 230 may determine whether a touch occurs and the touch coordinates based on the first sensing data.

On the other hand, when the touch type judgment part 310 determines that the touch type is the second type or the third type, the coordinate calculator 230 may input the second sensing data with the compensated touch sensitivity. In such a case, the coordinate calculator 230 may determine whether a touch occurs and the touch coordinates based on the second sensing data.

On the other hand, the coordinate calculator 230 may compare the first sensing data or the second sensing data with a predetermined touch reference value, and judge, as touch input data, the first sensing data or the second sensing data that is greater than the touch reference value. On the other hand, the coordinate calculator 230 may judge, as data with no touch input, the first sensing data or the second sensing data that is less than the touch reference value.

The coordinate calculator 230 may calculate touch coordinates for touch input data by executing a preset touch coordinate calculation algorithm. The touch coordinate calculation algorithm may be implemented using any known algorithm.

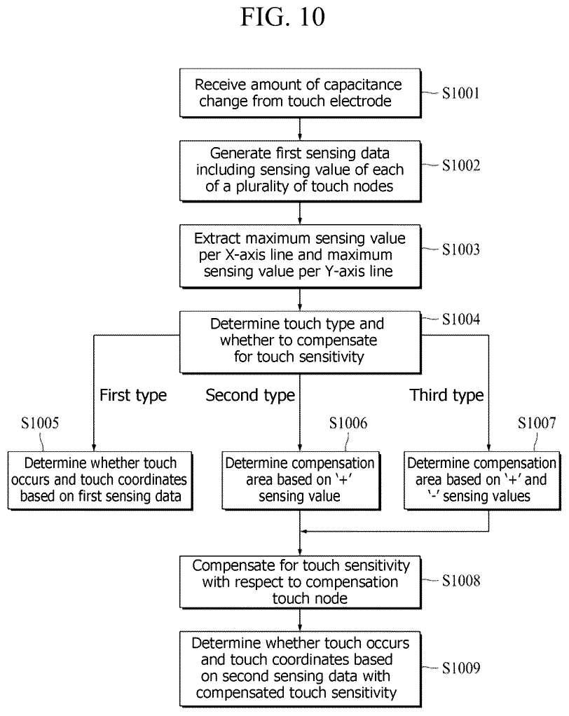

FIG. 10 is a flowchart for explaining a touch sensing method performed by the touch sensing device according to an embodiment of the present invention.

Referring to FIG. 10, first, the touch sensing device 170 receives the amount of capacitance change from a touch electrode (S1001). Specifically, the touch sensing device 170 may supply a drive signal to the first touch electrodes through the first touch lines and receive the amount of capacitance change in each of the touch sensors through the second touch lines.

Subsequently, the touch sensing device 170 generates first sensing data including a sensing value of each of a plurality of touch nodes based on the amount of capacitance change (S1002).

Specifically, the touch sensing device 170 may sample the amounts of capacitance change in the touch sensors received through the second touch lines and convert the sampled amounts into touch raw data being digital data. The touch sensing device 170 may generate the first sensing data including the sensing value of each of the plurality of touch nodes based on the touch raw data. The touch sensing device 170 may set a baseline based on the touch raw data, and determine a generated difference value as a sensing value. The touch sensing device 170 may determine a difference value between initial raw data and the touch raw data as a sensing value with respect to each of the plurality of touch nodes.

Subsequently, the touch sensing device 170 extracts a maximum sensing value per X-axis line and a maximum sensing value per Y-axis line from the first sensing data (S1003).

Specifically, the touch sensing device 170 may extract the maximum sensing value with respect to each of the plurality of X-axis lines. Each of the plurality of X-axis lines may include the sensing value of each of the plurality of touch nodes arranged in parallel in the X-axis direction. The touch sensing device 170 may determine a maximum value among the sensing values of the plurality of touch nodes arranged on the X-axis line, as the maximum sensing value for the X-axis line.

The touch sensing device 170 may extract the maximum sensing value with respect to each of the plurality of Y-axis lines. Each of the plurality of Y-axis lines may include the sensing values of each of the plurality of touch nodes arranged in parallel in the Y-axis direction. The touch sensing device 170 may determine a maximum value among the sensing values of the plurality of touch nodes arranged on the Y-axis line, as the maximum sensing value for the Y-axis line.

Subsequently, the touch sensing device 170 determines a touch type and whether to compensate for touch sensitivity based on the maximum sensing value per X-axis line and the maximum sensing value per Y-axis line in the data (S1004).

Specifically, the touch sensing device 170 may determine one of the first type, the second type, and the third type as the touch type based on the maximum sensing value per X-axis line and the maximum sensing value per Y-axis line. The touch sensing device 170 may determine X-axis touch groups and Y-axis touch groups based on the maximum sensing value per X-axis line and the maximum sensing value per Y-axis line. The touch sensing device 170 may determine the touch type by using at least one of the range and number of each of the determined X-axis touch groups and Y-axis touch groups.

The touch sensing device 170 may calculate a touch area by using the range of the X-axis touch group and the range of the Y-axis touch group. The touch area is the size of the touch area and may correspond to the number of touch nodes arranged in an area where the range of the X-axis touch group and the range of the Y-axis touch group intersect with each other. When the touch area is less than a preset area reference value, the touch sensing device 170 may determine the touch type as the first type. When there are a plurality of touch areas and all of the plurality of touch areas are less than the preset area reference value, the touch sensing device 170 may determine not to compensate for touch sensitivity and determine the touch type as the first type.

In addition, when the number of the X-axis touch groups and the number of the Y-axis touch groups are all 2 or more, the touch sensing device 170 may determine not to compensate for the touch sensitivity and determine the touch type as the first type.

On the other hand, when the touch area is equal to or greater than the area reference value and the number of X-axis touch groups and the number of Y-axis touch groups are all 1, the touch sensing device 170 may determine to compensate for the touch sensitivity and determine the touch type as the second type. The second type may represent a large-area single touch. In addition, when the touch area is equal to or greater than the area reference value and one of the number of X-axis touch groups and the number of Y-axis touch groups is 1 and the other is 2 or more, the touch sensing device 170 may determine to compensate for the touch sensitivity and determine the touch type as the third type. The third type may represent a large-area multi-touch made on the same line.

Subsequently, when the touch type is the first type, the touch sensing device 170 determines whether a touch occurs and the touch coordinates based on the first sensing data (S1005).

On the other hand, when the touch type is the second type or the third type, the touch sensing device 170 determines a compensation area for performing the touch sensitivity compensation. Specifically, when the touch type is the second type, the touch sensing device 170 determines the compensation area based on a positive (+) sensing value among the sensing values of the plurality of touch nodes (S1006).

The touch sensing device 170 may predict one touch area by comparing the positive (+) sensing value among the sensing values of the plurality of touch nodes included in the first sensing data with the first touch reference value. The touch sensing device 170 may compare the sensing value with the first touch reference value while scanning an entire area or a partial area.

The touch sensing device 170 may sequentially scan the sensing values of the touch nodes along the line. In an embodiment, the touch sensing device 170 may sequentially scan the sensing values of the touch nodes along the X-axis direction with respect to each of the plurality of X-axis lines and compare the sensing values with the first touch reference value. In such a case, the touch sensing device 170 may scan an entire area, scan a partial area within the range of the X-axis touch group, or scan a partial area where the range of the X-axis touch group and the range of the Y-axis touch group intersect with each other.

In another embodiment, the touch sensing device 170 may sequentially scan the sensing values of the touch nodes along the Y-axis direction with respect to each of the plurality of Y-axis lines and compare the sensing values with the first touch reference value. In such a case, the touch sensing device 170 may scan an entire area, scan a partial area within the range of the Y-axis touch group, or scan a partial area where the range of the X-axis touch group and the range of the Y-axis touch group intersect with each other.

The touch sensing device 170 may determine a start node and an end node with respect to each line, and predict a gap between the start node and the end node as a touch area. In an embodiment, the touch sensing device 170 may sequentially scan the sensing values of the touch nodes along the X-axis line, determine, as the start node, a first touch node whose sensing value is greater than the first touch reference value, and determine, as the end node, a last touch node whose sensing value is greater than the first touch reference value. In such a case, a Y-axis line, where the start node is arranged, and a Y-axis line, where the end node is arranged, may be included in the range of the Y-axis touch group. The touch sensing device 170 may predict the gap between the start node and the end node as the touch area with respect to each of the plurality of X-axis lines.

In another embodiment, the touch sensing device 170 may sequentially scan the sensing values of the touch nodes along the Y-axis line, determine, as the start node, a first touch node whose sensing value is greater than the first touch reference value, and determine, as the end node, a last touch node whose sensing value is greater than the first touch reference value. In such a case, an X-axis line, where the start node is arranged, and an X-axis line, where the end node is arranged, may be included in the range of the X-axis touch group. The touch sensing device 170 may predict the gap between the start node and the end node as the touch area with respect to each of the plurality of Y-axis lines.

The touch sensing device 170 may determine one predicted touch area as a compensation area.

On the other hand, when the touch type is the third type, the touch sensing device 170 determines the compensation area based on positive (+) and negative (−) sensing values among the sensing values of the plurality of touch nodes (S1007).

The touch sensing device 170 may compare the absolute values of the positive (+) and negative (−) sensing values among the sensing values of the plurality of touch nodes included in the first sensing data with the second touch reference value, and predict at least two or more touch areas. The touch sensing device 170 may compare the sensing values with the second touch reference value while scanning an entire area or a partial area.

The touch sensing device 170 may sequentially scan the sensing values of the touch nodes along the line. In an embodiment, the touch sensing device 170 may sequentially scan the sensing values of the touch nodes along the X-axis direction with respect to each of the plurality of X-axis lines and compare the absolute values of the sensing values with the second touch reference value. In such a case, the touch sensing device 170 may scan an entire area, scan a partial area within the range of the X-axis touch group, or scan a partial area where the range of the X-axis touch group and the range of the Y-axis touch group intersect with each other.

In another embodiment, the touch sensing device 170 may sequentially scan the sensing values of the touch nodes along the Y-axis direction with respect to each of the plurality of Y-axis lines and compare the absolute values of the sensing values with the second touch reference value. In such a case, the touch sensing device 170 may scan an entire area, scan a partial area within the range of the Y-axis touch group, or scan a partial area where the range of the X-axis touch group and the range of the Y-axis touch group intersect with each other.

The touch sensing device 170 may determine a start node and an end node with respect to each line, and predict a gap between the start node and the end node as a touch area. In an embodiment, the touch sensing device 170 may sequentially scan the sensing values of the touch nodes along the X-axis line, determine, as the start node, a first touch node whose absolute value of the sensing value is greater than the second touch reference value, and determine, as the end node, a last touch node whose absolute value of the sensing value is greater than the second touch reference value. In such a case, a Y-axis line, where the start node is arranged, and a Y-axis line, where the end node is arranged, may be included in any one of the range of one Y-axis touch group and the Y-axis margin range. The touch sensing device 170 may predict the gap between the start node and the end node as the touch area with respect to each of the plurality of X-axis lines.

In another embodiment, the touch sensing device 170 may sequentially scan the sensing values of the touch nodes along the Y-axis line, determine, as the start node, a first touch node whose absolute value of the sensing value is greater than the second touch reference value, and determine, as the end node, a last touch node whose absolute value of the sensing value is greater than the second touch reference value. In such a case, an X-axis line, where the start node is arranged, and an X-axis line, where the end node is arranged, may be included in any one of the range of the X-axis touch group and the X-axis margin range. The touch sensing device 170 may predict the gap between the start node and the end node as the touch area with respect to each of the plurality of Y-axis lines.

The touch sensing device 170 may determine at least two predicted touch areas as at least two compensation areas.

Subsequently, the touch sensing device 170 compensates for touch sensitivity with respect to each of compensation touch nodes included in the compensation area (S1008).

Specifically, the touch sensing device 170 may determine a compensation value for each of the compensation touch nodes, and generate second sensing data by adding the compensation value to the sensing value of each of the compensation touch nodes. The touch sensing device 170 may determine a compensation value for a corresponding compensation touch node based on the average value of the maximum sensing value of the X-axis line and the maximum sensing value of the Y-axis line, where the compensation touch nodes being located on the X-axis line and the Y-axis line.

In an embodiment, the touch sensing device 170 may determine the average value of the maximum sensing value of the X-axis line and the maximum sensing value of the Y-axis line as a compensation value for a corresponding compensation touch node, the compensation touch nodes being located on the X-axis line and the Y-axis line.

In another embodiment, the touch sensing device 170 may determine a compensation value for a corresponding compensation touch node based on the average value of the maximum sensing value of the X-axis line and the maximum sensing value of the Y-axis line and a weight for the compensation touch node, the compensation touch nodes being located on the X-axis line and the Y-axis line. The touch sensing device 170 may determine a sensing period including the sensing value of the compensation touch node among a plurality of sensing periods, and determine a weight corresponding to the determined sensing period as the weight for the compensation touch node. The touch sensing device 170 may determine the compensation value for the compensation touch node by multiplying the average value of the maximum sensing value of the X-axis line and the maximum sensing value of the Y-axis line by the weight.

Subsequently, the touch sensing device 170 determines whether a touch occurs and the touch coordinates based on the second sensing data with the compensated touch sensitivity (S1009).

Those skilled in the art to which the present invention pertains may understand that the present invention described above may be carried out in other specific forms without departing from the technical spirit or essential features thereof.

In addition, the methods described in the present specification may be implemented at least partially by using one or more computer programs or components. This component may be provided as a series of computer instructions via a computer-readable medium or a machine-readable medium including volatile and nonvolatile memories. The instructions may be provided as software or firmware, and may be implemented, in whole or in part, in hardware configurations such as ASICs, FPGAs, DSPs, or other similar elements. The instructions may be configured to be executed by one or more processors or other hardware configurations, and when the series of computer instructions are executed, the processors or other hardware configurations perform or cause to perform all or a part of the methods and procedures disclosed in the present specification.

The present specification described above is not limited by the aforementioned embodiment and the accompanying drawings, and it will be obvious to those skilled in the art to which the present specification pertains that various replacements, modifications, and changes may be made without departing from the technical spirit of the present specification. The scope of the present specification is defined by the claims to be described below, and it should be construed that all changes or modified forms derived from the meaning and scope of the claims and the equivalent concept thereof are included in the scope of the present specification.

[List of Reference Numbers]

| | |
|---|---|
| 100: Display device | 110: Display panel |
| 131: Data driving circuit | 132: Gate driving circuit |
| 133: Timing controller | 130: Display driving device |
| 171: First circuit | 172: Second circuit |
| 173: Third circuit | 170: Touch sensing device |
| 210: Touch signal processor | 220: Compensation processor |
| 230: Coordinate calculator | 310: Touch type judgment part |
| 320: Compensation area determination | 330: Compensation part |
| part | |

1. A touch sensing device comprising:
a first circuit configured to supply a drive signal to a touch electrode;
a second circuit configured to sense an amount of capacitance change occurring in the touch electrode; and
a third circuit configured to generate first sensing data including a sensing value of each of a plurality of touch nodes based on the sensed amount of capacitance change, and to generate second sensing data by adding a compensation value to the sensing value of at least one of the plurality of touch nodes in order to compensate for touch sensitivity based on the first sensing data.

2. The touch sensing device of claim 1, wherein the third circuit comprises:
a compensation processor configured to determine any one of a first type, a second type, and a third type as a touch type based on the first sensing data, and to generate the second sensing data by adding the compensation value to the sensing value of at least one of the plurality of touch nodes.

3. The touch sensing device of claim 2, wherein the compensation processor comprises:
a touch type judgment part configured to extract a maximum sensing value per X-axis line and a maximum sensing value per Y-axis line from the first sensing data, and to determine the touch type by using the maximum sensing value per X-axis line and the maximum sensing value per Y-axis line or X-axis touch groups and Y-axis touch groups determined based on the maximum sensing value per X-axis line and the maximum sensing value per Y-axis line.

4. The touch sensing device of claim 3, wherein the touch type judgment part calculates a touch area by using a range of the X-axis touch group and a range of the Y-axis touch group, determines the first type as the touch type when the touch area is less than a reference value or the number of the X-axis touch groups and the number of the Y-axis touch groups are all 2 or more, and
determines the second type as the touch type when the number of the X-axis touch groups and the number of the Y-axis touch groups are all 1, and determines the third type as the touch type when one of the number of the formed X-axis touch ranges and the number of the formed Y-axis touch ranges is 1 and the other is 2 or more.

5. The touch sensing device of claim 2, wherein the compensation processor comprises:
a compensation area determination part configured to, when the touch type is any one of the second type and the third type, predict the touch area by comparing the sensing value of each of the plurality of touch nodes included in the first sensing data with a touch reference value, and to determine the predicted touch area as a compensation area.

6. The touch sensing device of claim 5, wherein, when the touch type is the second type, the compensation area determination part predicts one touch area by comparing the sensing value of each of the plurality of touch nodes included in the first sensing data with a first touch reference value.

7. The touch sensing device of claim 5, wherein, when the touch type is the third type, the compensation area determination part predicts at least two touch areas by comparing an absolute value of the sensing value of each of the plurality of touch nodes included in the first sensing data with a second touch reference value.

8. The touch sensing device of claim 2, wherein the compensation processor comprises:
a compensation part configured to determine a compensation value for each of compensation touch nodes included in a compensation area based on a maximum sensing value per X-axis line and a maximum sensing value per Y-axis line extracted from the first sensing data, and to generate the second sensing data by adding the compensation value to a sensing value of each of the compensation touch nodes.

9. The touch sensing device of claim 8, wherein the compensation processor determines a compensation value for a compensation touch node provided at a location, where the X-axis line and the Y-axis line intersect with each other, by using an average value of the maximum sensing value of the X-axis line and the maximum sensing value of the Y-axis line, each of the compensation touch nodes being located on the X-axis line and the Y-axis line, or a weight determined based on the sensing values of the compensation touch nodes.

10. The touch sensing device of claim 1, wherein the touch electrode includes a first touch electrode arranged in a first direction and a second touch electrode arranged in a second direction, and
the first touch electrode receives the drive signal supplied from the first circuit, and the second touch electrode transmits the amount of capacitance change in each of the plurality of touch nodes to the second circuit.
